(19) United States
(12) Patent Application Publication
(10) Pub. No.: US 2004/0036784 A1
(43) Pub. Date: Feb. 26, 2004

(54) High dynamic range pixel with gain and true shutter capability

(76) Inventor: Nikolai E. Bock, Pasadena, CA (US)

Correspondence Address: DICKSTEIN SHAPIRO MORIN & OSHINSKY LLP, 2101 L STREET NW, WASHINGTON, DC, 20037-1526, US

(21) Appl. No.: 10/226,075

(22) Filed: Aug. 23, 2002

(51) Int. Cl. H04N 5/335

(52) U.S. Cl. 348/308

(57) ABSTRACT

A pixel architecture and associated three phase operating method for a CMOS active pixel sensor system is disclosed. The first phase is an accumulation phase, charges from the incident light as well as charges accumulated since after the prior cycle's accumulation phase are used to charge a node to control a source follower transistor. The second phase is a read-out phase, which shuts off the transfer transistor to isolate the photodiode from the source follower transistor while an the source follower transistor causes an electrical signal to be output from the pixel. The third phase is a reset phase which couples the node used to control the source follower transistor to a reset potential source. The architecture of the pixel of the present invention is capable of responding across a wide dynamic range of incident light while exhibiting minimal fixed pattern noise.

### FIELD OF INVENTION

The present invention relates to a CMOS active pixel sensor system. More specifically, the present invention is directed to a pixel architecture having a high dynamic range, shutter capability, and low fixed pattern noise.

### BACKGROUND OF THE INVENTION

FIG. 1 is an illustration of a conventional CMOS active pixel sensor (APS) imaging system 100. The system 100 includes a N×M array 110 of pixels P. System 100 may be monochromatic or color. If system 100 is a color system, the pixels P in the array 110 would be made sensitive to the primary colors of red, green, or blue, and would typically be arranged in a Bayer pattern in which alternating rows are comprised of green/red and blue/green sensitive pixels in adjacent columns.

Each pixel P in the array 110 converts incident light into electrical energy, which is output as an electrical signal. The signals from the N pixels which form a row in the N×M pixel array are typically simultaneously output on respective column lines to respective sample-and-hold circuits 120, which store the electrical signals. These signals are then selected, one pixel at a time, for further processing by a driver 130, and then converted into a digital signal by the digital-to-analog converter 140. The digital signals are further processed by a digital processing section 150, and then stored by a storage device 160. When all the signals stored in the sample-and-hold circuits 120 have been processed, another row of signals is output and stored in the sample-and-hold circuit and the processing continues until each row of the N×M array has been processed. The above described processing may be controlled by a control circuit 170. Alternatively, control circuit 170 may include a plurality of control circuits.

At the heart of any imaging system 100 is the pixel P. An ideal pixel would have a high dynamic range while exhibiting low fixed pattern noise and have a shutter capability. High dynamic range refers to the ability of the pixel to generate electrical signals which distinguish between a wide range of brightness levels. Low fixed pattern noise refers to the ability of the pixel to output an electrical signal which is primarily based upon the intensity of the incident light and minimally related to electrical noise within the pixel. Shutter capability refers to the ability of the pixel to independently accumulate charge for the next frame while the current frame is being read out.

FIG. 2 illustrates a conventional logarithmic pixel 200. The logarithmic pixel 200 includes a photodiode 210, which is coupled to node-A. The pixel 200 also includes a transistor 220 with one source/drain terminal and its gate coupled to a V_{dd} potential source and another source/drain terminal coupled to node-A. The pixel 200 is designed so that transistor 220 operates in sub-threshold conduction. The voltage at node-A depends logarithmically on the photocurrent. Node-A is coupled to the gate of a source follower transistor 230, which has one source/drain terminal coupled to a V_{dd} potential source and another source/drain terminal coupled to a row select transistor 240. As known in the art, a ROW signal is applied to each pixel in a selected row to switch on the pixel's row select transistor 240, to enable the signal controlled by the voltage at node-A to be output at node B, for output to the sample-and-hold circuit 120 (FIG. 1).

Thus, the logarithmic voltage level at node-A to permits the pixel 200 to be responsive over a wide dynamic range. Unfortunately, the logarithmic pixel 200 suffers from considerable fixed pattern noise and low voltages produced at node-A due to the need to operate transistor 220 in the sub-threshold conduction mode.

FIG. 3 illustrates a linear-logarithmic pixel 300. The pixel 300 includes each component of the logarithmic pixel 200 and adds new circuitry to biasing node-A. More specifically, the additional circuit includes a reset transistor 310, which has one source/drain terminal coupled to a Vᵣₛₜ potential source and another source/drain terminal coupled to node-A. The transistor 310 has its gate coupled to the RST signal. The Vᵣₛₜ potential is set at a level so that when transistor 310 conducts, the voltage at node-A is set below the sub-threshold conduction level of transistor 220. This causes the voltage at node-A to rise linearly. As the voltage at node-A increases, it may eventually rise to a level sufficient to cause transistor 220 to reach a sub-threshold conduction state. At that point, the rate of change in the voltage at node-A becomes logarithmic. This combination response can been seen in FIG. 3B, which shows a linear response region before the knee point K and a logarithmic response after the knee point K. The location of the knee is a function of the threshold voltage of transistor 220 and the Vᵣₛₜ voltage level. The location of the knee point K may therefore be altered by changing the voltage level Vᵣₛₜ. In particular, as the gap between Vᵣₛₜ and V_{dd} increases, the length of time the voltage at node-A (V_{A}) remains in linear mode increases.

The pixel 300 is an improvement over pixel 200, with respect to dynamic range capability. Variations on the linear-logarithmic pixel 300 include adding transistors in series with transistor 220, to create a pixel having one linear stage and multiple logarithmic stages (not illustrated). However, the pixel 300 (and its multiple logarithmic stage variations) inherits the fixed pattern noise problem of the standard logarithmic pixel. The knee point of the response is dependent upon the threshold voltage of transistor 220. Finally, pixel 300 does not have a shutter capability.

Accordingly, there is a need and desire for wide dynamic range pixel with shutter capability and having good sensitivity and good noise characteristics.

### SUMMARY OF THE INVENTION

The present invention is directed to a new pixel architecture having improved dynamic range, sensitivity, good fixed pattern noise characteristics, and shutter capability. The pixel of the present invention includes an anti-blooming gate and a transfer gate, coupled in series with the photodiode in the middle. A reset gate is coupled to a node on the opposite side of the transfer gate relative to the photodiode. The pixel of the present invention can be operated such that charge accumulates on the photodiode side of the transfer gate while the previous charge on the reset side of the transfer gate is being read out.

The foregoing and other advantages and features of the invention will become more apparent from the detailed description of exemplary embodiments of the invention given below with reference to the accompanying drawings.

### BRIEF DESCRIPTION OF THE DRAWINGS

FIG. 1 is a block diagram of a front-end portion of a CMOS APS system;

FIG. 2 is a block diagram of a logarithmic pixel;

FIG. 3A is a block diagram of a linear-logarithmic pixel;

FIG. 3B is a graph illustrating the response of the linear-logarithmic pixel;

FIG. 4 is a block diagram the pixel of the present invention;

FIGS. 5A, 5B, 5C respectively illustrate the accumulation, read-out, and reset phases of the pixel of the present invention;

FIG. 6 illustrates an accumulation phase beginning with increased charge due to charge accumulation during the prior read-out and reset phases;

FIG. 7 illustrates how excess charge generated during an accumulation phase can be transferred through the anti-blooming gate; and

FIG. 8 is a timing diagram for the pixel of the present invention.

### DETAILED DESCRIPTION OF THE INVENTION

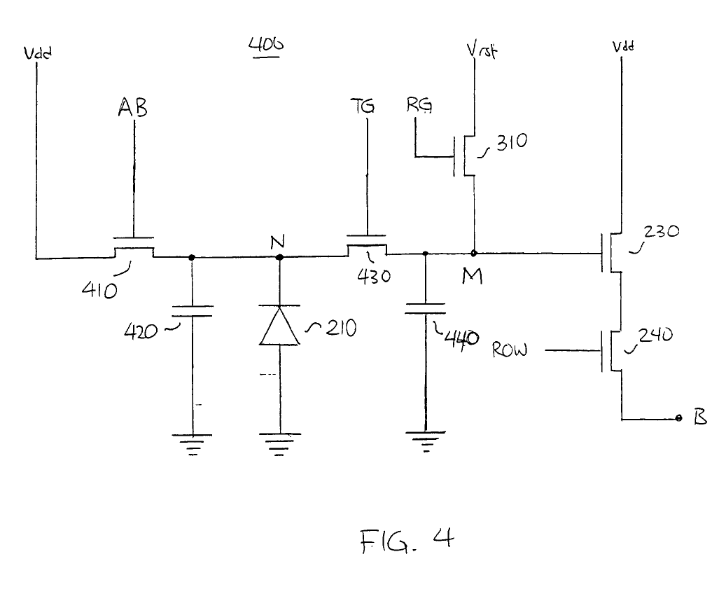

Now referring to the drawings, where like reference numerals designate like elements, there is shown in FIG. 4 a diagram of the pixel 400 in accordance with the present invention. The pixel 400 includes an anti-blooming transistor 410 having one source/drain terminal coupled to a V_{dd} potential source and having another source/drain terminal coupled to node-N. The anti-blooming transistor 410 has a gate coupled to control signal AB. Also coupled to node-N is the photodiode 210 and capacitor 420. Capacitor 420 may represent the capacitance of the photodiode 210, or may be a discrete capacitor. The pixel 400 also includes a transfer gate transistor 430 having one source/drain terminal coupled to node-N and another source/drain terminal coupled to node-M. The transfer gate transistor 430 has its gate coupled to control signal TG. Also coupled to node-M is a capacitor 440, which may represent the parasitic capacitance at node-M, or, alternatively, a discrete capacitor. The gain of the pixel is determined by the capacitance of capacitor 420 divided by the capacitance of capacitor 440. Accordingly, the capacitance of capacitors 420, 440 may be adjusted as desired to reach a suitable gain level for the pixel.

A Vᵣₛₜ potential source is coupled to one source/drain terminal of reset transistor 310, which has another source/drain terminal coupled to node-M. The gate of the reset transistor 310 is coupled to control signal RG. Node-M is also coupled to the gate of the source follower transistor 230, which has one source/drain terminal coupled to a V_{dd} potential source and another source/drain terminal coupled to a source/drain terminal of row select transistor 240. The row select transistor 240 has another source/drain terminal coupled to output node-B, and its gate coupled to the ROW control signal.

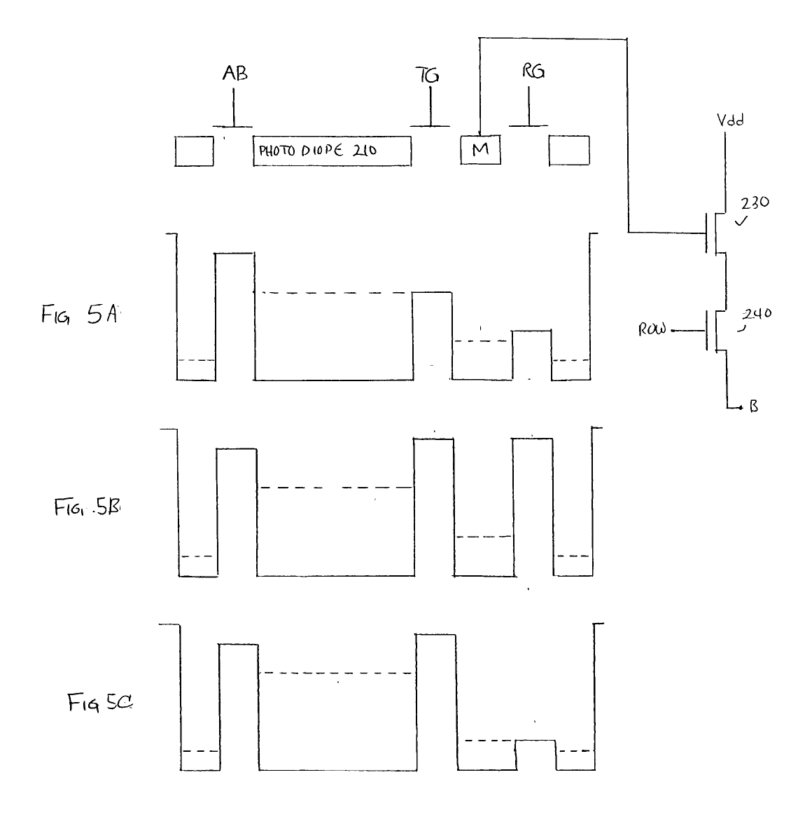

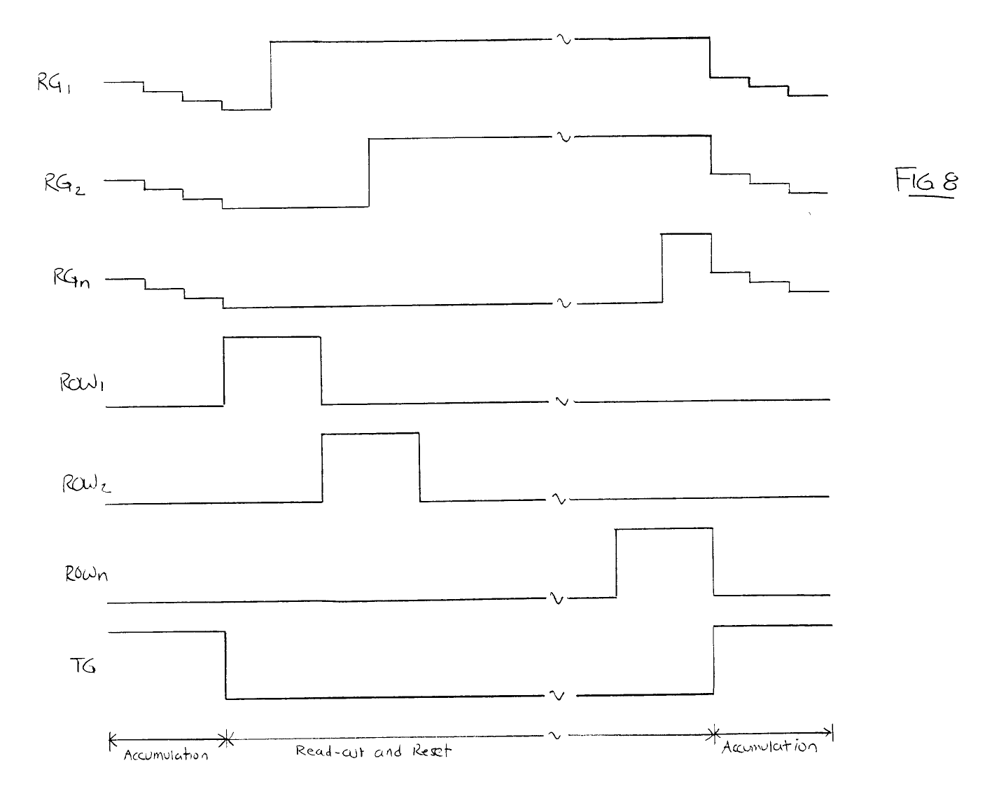

The operation of the pixel 400 is now explained in conjunction with the charge/barrier diagrams of FIGS. 5A-5C, 6, and 7, and the timing diagram of FIG. 8. The charge/barrier diagrams of FIGS. 5A-5C, 6, and 7 include at the top portion of each figure, a cross section representation of the circuit of pixel 400 including the portion between the anti-blooming transistor 410 and the reset transistor 310. Below that is a depiction of the charge accumulation levels and barrier heights in the corresponding portions of the pixel 400. The charge accumulation levels are illustrated by dashed lines, while the barrier heights are illustrated with solid lines. The barrier levels in the pixel 400 move dynamically. For example, when the voltage on a gate of a transistor is changed to cause the transistor to conduct, the barrier level at that gate decreases, to permit charge to move from one source/drain area to another source/drain area.

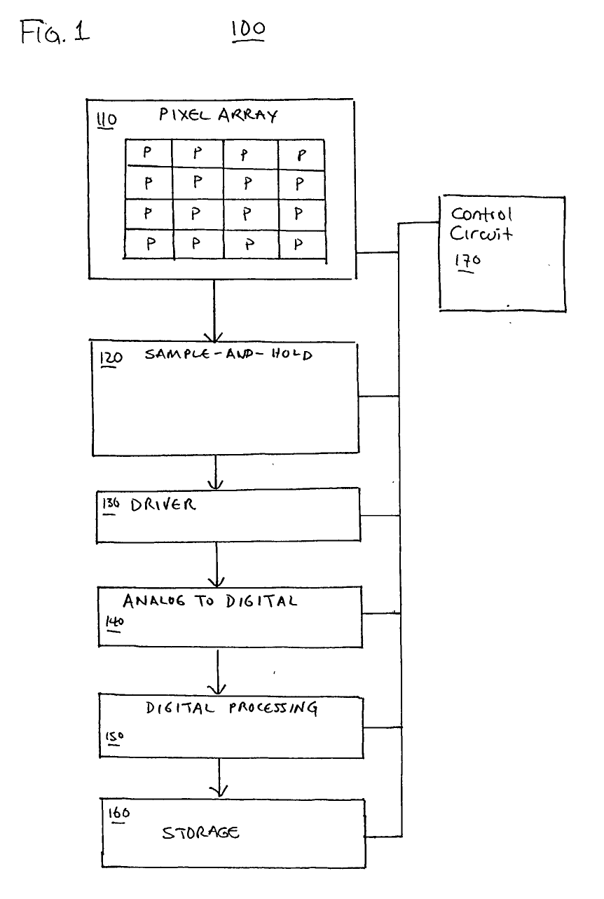

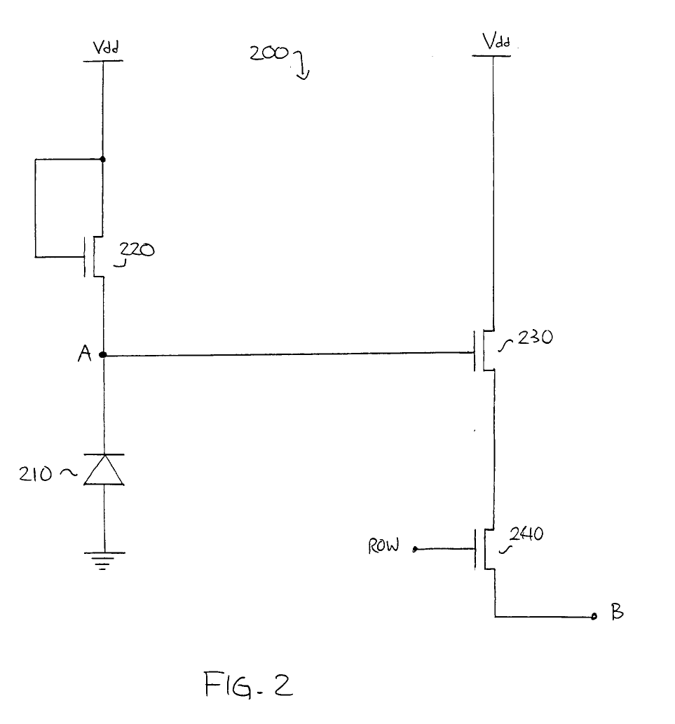

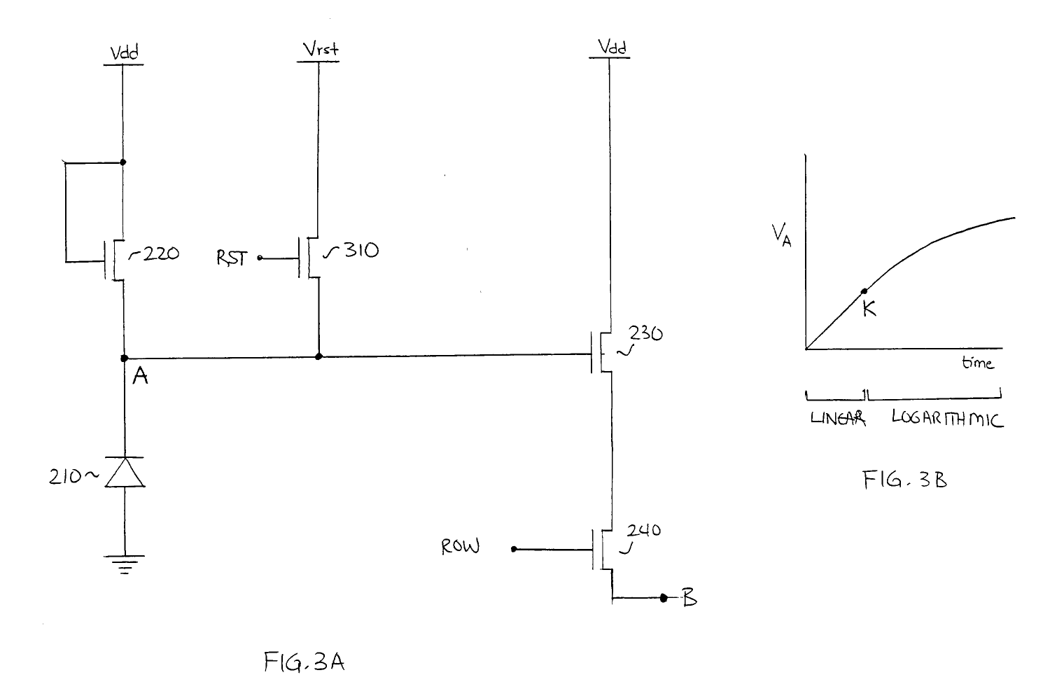

The charge/barrier diagrams of FIGS. 5A-5C, 6, and 7 relate to the operation of a single pixel. The timing diagram of FIG. 8 illustrates how the RGᵢ, ROWᵢ, and TG signals vary during the operation of the entire array 110. More specifically, the TG signal is a single control signal applied to every pixel 400 in the array, while the RGᵢ and ROWᵢ signals are control signals applied to every pixel 400 in row i of the array 110, where row i is the current row being processed. The sequencing of the control signals may be performed by a suitable control circuit, for example, control circuit 170 (FIG. 1). The operation of pixel 400 can be characterized in three cycle phases. The first phase is the accumulation phase, the second phase is the read-out phase, and the third phase is the reset phase. As will become apparent from the description below, the read-out and reset phases of pixels in different rows will overlap, while all pixels will under go the accumulation phase at the same time.

The charge/barrier diagram corresponding to the accumulation phase is FIG. 5A. During the accumulation phase, the control signals ROWᵢ (for all i) are at a low state thereby causing the row transistor 240 to become non-conducting. Additionally, the control signals RGᵢ (for all i) begin at a voltage level below that required to cause the reset transistor to conduct and is gradually is reduced over time. This causes the barrier in the reset transistor 310 to increase. The TG control signal is high, thereby causing the transfer gate transistor 430 to conduct while reducing the barrier level at the transfer gate transistor 430. This permits the photodiode 210 to charge node-M.

A stepped barrier technique is used under the gate of the reset transistor 310 to increase the dynamic range of the pixel 400. I.e., the barrier height under the gate of the reset transistor 310 goes up in steps during the integration time. If the illumination is low, the charge accumulation rate at node-M is constant and less than the rise rate of the barrier under the gate of the reset transistor 310, thereby permitting node-M to accurately account for the charging by the photodiode 210 . If the illumination is high, the charge accumulation rate at node-M is faster than the rise rate of the barrier under the gate of the reset transistor 310, but this charge accumulation rate can be limited by a lateral charge overflow through the barrier. This compression of the photo-signal is dependent upon the way the barrier height steps are generated.

The read-out and reset phases begins with the first row (i=1), and continues with each successive row until every row has been processed (i=N, for a N×M array). For example, for every pixel in row 1, the charge/barrier diagram corresponding to the read-out phase is FIG. 5B. In this phase, the TG control signal transitions from high to low, thereby isolating node-M from the photodiode 210. Additionally, the ROW₁ signal transitions high, thereby permitting the source follower transistor 230 to output an electrical signal controlled by the voltage at node-M. The RG₁ control signal has also reached its lowest state, thereby ensuring that the reset gate remains non-conductive. During the read-out phase, the photodiode 210 of each pixel in the current row, while isolated by a non-conducting transfer gate transistor 430, continues to accumulate charge.

For row 1, the charge/barrier diagram corresponding to the reset phase is FIG. 5C. In this phase, the ROW₁ control signal remains high to permit node-M to cause the source follower transistor 230 to output a reset signal, and then transitions low. The control signal RG₁ is high thereby causing the reset transistor 310 to couple the reset potential source Vᵣₛₜ to node-M. The high level of RG₁ is used to implement a soft reset. The potential at node-M of each pixel in the current row i is: V_{M}=V_{RG}−Vₜₕ. The soft reset allows getting knee point independent of the threshold voltage of the RG transistor. After readout of the whole array of pixels RG signal jumps to lower level, which creates potential barrier under the gate of RG transistor separating node-M from the Vᵣₛₜ source. At that time, the TG signal return to its high level to permit charging of node-M by the photocurrent.

Each successive row begins its read-out and reset phases when the ROWᵢ signal for the previous row transitions low to shut off the output of the reset signal. As shown in FIG. 8, the RGᵢ and ROWᵢsignals for each row operate in a similar manner, varying only with respect to when the ROWᵢ signals transition high to begin the read-out phase and when the RGᵢ signal transition high to begin and end the output of the reset signal. This process continues until the final row (i=N) has been processed, as indicated by the signal traces for signals RG_{N} and ROW_{N}. The process can then be repeated.

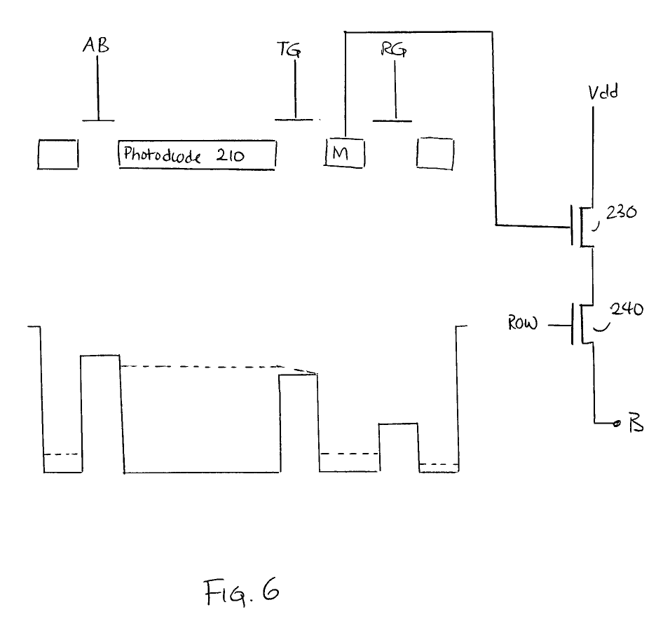

One advantage of the pixel 400 of the present invention is that the transfer gate transistor 430 isolates the photodiode 210 during the read-out phase. This permits the charge collected by the photodiode 210 during the current cycle's read-out phase to be available for use during the next cycle's accumulation phase. This situation is illustrated in FIG. 6, which, along with the final portion of FIG. 8, illustrate the next cycle's accumulation phase after the photodiode 210 has been accumulating charges since the previous read-out and reset phases. In the beginning of the next accumulation phase, when TG signal goes up all charge collected in photodiode during readout and rest phase spills into node-M. The quantity of charge accommodated by node-M is limited by the height of barrier under the RG gate. In the case of high illumination, extra charge collected in readout time overflows into Vᵣₛₜ source.

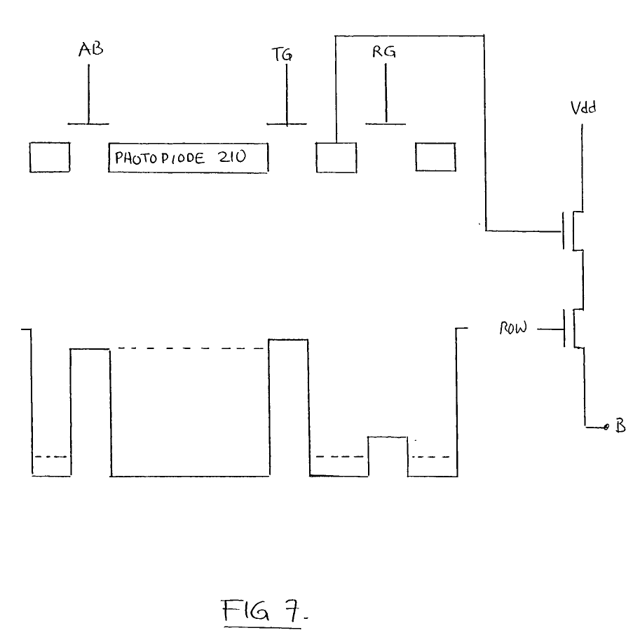

If the incident light is of an especially high intensity, there is the possibility of overflowing the photodiode's 210 well as it accumulates charges during the read-out and (soft) reset phases. Such a situation is illustrated in FIG. 7, where new accumulated charge in the photodiode 210 overflows through the anti-blooming transistor 410. The control signal AB is set on a per pixel basis and is adjusted so that the barrier of the anti-blooming transistor 410 is slightly less than the barrier of the transfer gate transistor during the read-out and reset phases. This permits excess charge to flow from the photodiode 210 well through the anti-blooming transistor 410, if necessary.

The present invention is therefore directed at a pixel architecture having a transfer transistor, an anti-blooming transistor, and a reset transistor. The pixel of the present invention is operated in a three phase cycle. The first phase is an accumulation phase, charges from the incident light as well as charges accumulated since after the prior cycle's accumulation phase are used to charge a node to control a source follower transistor. The second phase is a read-out phase, which shuts off the transfer transistor to isolate the photodiode from the source follower transistor while an the source follower transistor causes an electrical signal to be output from the pixel. The third phase is a reset phase which couples the node used to control the source follower transistor to a potential source. During the read-out and reset phases, the photodiode continues to accumulate charges. The charges accumulated during the readout and reset phases are made available to the next accumulation phase. In the rare instances where the photodiode has accumulated too much charge, excess charge is allowed to bleed from the photodiode through the anti-blooming transistor. The architecture of the pixel of the present invention is capable of responding across a wide dynamic range of incident light while exhibiting minimal fixed pattern noise.

While the invention has been described in detail in connection with the exemplary embodiment, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed as new and desired to be protected by Letters Patent of the United States is:

1. A method of operating a pixel, comprising:
accumulating charge at a charge accumulation node based on incident light;
transferring accumulated charge from said accumulation node to a read-out node;
reading-out charge from said read-out node while accumulating new charge at said accumulation node; and
resetting at least said read-out node to a predetermined state prior to transferring said accumulated charge thereto;
wherein,
during said accumulating, applying at a first voltage and then applying a second voltage to the gate of said reset transistor,
said first voltage causing a gate barrier of said reset transistor to a first level which prevents said reset transistor from conducting, and
said second voltage causing said gate barrier of said reset transistor to a second level greater than said first level.

2. The method of claim 1, wherein said second voltage is less than said first voltage.

3. The method of claim 1, further comprising:
during said accumulating, applying a third voltage to the gate of the reset transistor;
wherein,
said third voltage is applied between application of said first and second voltages; and
said third voltage causes said gate barrier to increase to an intermediate level between said first and second levels.

4. The method of claim 3, wherein said first voltage is greater than said second and third voltages and said third voltage is greater than said second voltage.

5. The method of claim 1, further comprising:
during said accumulation, applying a sequence of voltages to the gate of the reset transistor;
wherein,
said sequence of voltages is applied between application of said first and second voltages; and
said first voltage, said sequence of voltages, and said second voltage cause said gate barrier to monotonically increase from said first level to said second level.

6. The method of claim 1, further comprising:
during said reading-out, applying a fourth voltage to the gate of said reset transistor;
wherein said fourth voltage causes the gate barrier of said reset transistor to increase to a maximum level.

7. The method of claim 1, further comprising:
during said reset phase, applying a fifth voltage to said gate of said reset transistor to cause said reset transistor to conduct, and then applying said first voltage to said gate of said reset transistor.

8. A circuit for controlling operation of a pixel, said circuit comprising:
a driver, for controlling a sequence of voltages applied to the gate of a reset transistor;
wherein
while said pixel is accumulating charge in a photodiode,
said driver applies a first voltage and then applies a second voltage to the gate of the reset transistor;
said first voltage causing a gate barrier of said reset transistor to a first level which prevents said reset transistor from conducting between a first and second source/drain terminals of said reset transistor; and
said second voltage causing the gate barrier to a second level greater than said first level.

9. The circuit of claim 8, wherein said second voltage is less than said first voltage.

10. The circuit of claim 8, wherein
during said accumulating,
said driver applies a third voltage to the gate of the reset transistor, said third voltage is applied between application of said first and second voltages; and
said third voltage causes said gate barrier to increase to an intermediate level between said first and second levels.

11. The circuit of claim 10, wherein said first voltage is greater than said second and third voltages and said third voltage is greater than said second voltage.

12. The circuit of claim 8, wherein
during said accumulation,
said driver applies a sequence of voltages to the gate of the reset transistor;
wherein
said sequence of voltages is applied between application of said first and second voltages; and
said first voltage, said sequence of voltages, and said second voltage cause said gate barrier to monotonically increase from said first level to said second level.

13. The circuit of claim 8, wherein
while a read-out node of said pixel is being read,
said driver applies a fourth voltage to the gate of said reset transistor;
wherein
said fourth voltage causes the gate barrier of said reset transistor to increase to a maximum level.

14. The circuit of claim 8, wherein
while a read-out node of said pixel is being reset to a predetermined state,
said driver applies a fifth voltage to said gate of said reset transistor to cause said reset transistor to conduct, and then applying said first voltage to said gate of said reset transistor.

15. An imaging system, said imaging system comprising:
a plurality of pixel organized into an array; and
a circuit for controlling pixel operation, said circuit further comprising,
a driver, for controlling a sequence of voltages applied to the gate of a reset transistor;
wherein
while said pixel is accumulating charge in a photodiode,
said driver applies a first voltage and then applies a second voltage to the gate of the reset transistor;
said first voltage causing a gate barrier of said reset transistor to a first level which prevents said reset transistor from conducting between a first and second source/drain terminals of said reset transistor; and
said second voltage causing the gate barrier to a second level greater than said first level.

16. The imaging system of claim 15, wherein said second voltage is less than said first voltage.

17. The imaging system of claim 15, wherein
during said accumulating,
said driver applies a third voltage to the gate of the reset transistor, said third voltage is applied between application of said first and second voltages; and
said third voltage causes said gate barrier to increase to an intermediate level between said first and second levels.

18. The imaging system of claim 17, wherein said first voltage is greater than said second and third voltages and said third voltage is greater than said second voltage.

19. The imaging system of claim 15, wherein
during said accumulation,
said driver applies a sequence of voltages to the gate of the reset transistor;
wherein
said sequence of voltages is applied between application of said first and second voltages; and
said first voltage, said sequence of voltages, and said second voltage cause said gate barrier to monotonically increase from said first level to said second level.

20. The imaging system of claim 15, wherein
while a read-out node of said pixel is being read,
said driver applies a fourth voltage to the gate of said reset transistor;
wherein
said fourth voltage causes the gate barrier of said reset transistor to increase to a maximum level.

21. The imaging system of claim 15, wherein
while a read-out node of said pixel is being reset to a predetermined state,
said driver applies a fifth voltage to said gate of said reset transistor to cause said reset transistor to conduct, and then applying said first voltage to said gate of said reset transistor.
